(19) United States
(12) Patent Application Publication
(10) Pub. No.: US 2026/0309901 A1
(43) Pub. Date: Oct. 8, 2026

(54) LIGHT DIFFUSING FILM, MANUFACTURING METHOD THEREOF, AND DISPLAY APPARATUS COMPRISING SAME

(71) Applicant: SAMSUNG ELECTRONICS CO., LTD., Suwon-si (KR)

(72) Inventors: Soonjung KIM, Suwon-si (KR); Naewon Jang, Suwon-si (KR); Wonyeop Jang, Suwon-si (KR); Minnyeong Han, Suwon-si (KR)

(73) Assignee: SAMSUNG ELECTRONICS CO., LTD., Suwon-si (KR)

(21) Appl. No.: 19/247,115

(22) Filed: Jun. 24, 2025

Related U.S. Application Data
(63) Continuation of application No. PCT/KR2023/019768, filed on Dec. 4, 2023.

(30) Foreign Application Priority Data
Jan. 20, 2023 (KR) 10-2023-0008911

(51) Int. Cl. G02B 5/02; G02B 1/04; G02F 1/1335

(52) U.S. Cl. CPC G02B 5/0268; G02B 5/0242; G02B 5/0257; G02F 1/133504; G02B 1/04; G02F 1/133562

(57) ABSTRACT

A method of manufacturing a light diffusion film includes preparing a cylindrical drum having protrusions extending in a length direction on an outer circumferential surface; moving a base film having a defined width in a first direction; rubbing the cylindrical drum on the base film to form a plurality of grooves extending in a second direction perpendicular to the first direction; supplying, to the moving base film, a mixture having anisotropic light diffusion particles and a resin to fill the plurality of grooves; and curing the resin of the mixture in the plurality of grooves. The light diffusion film includes a base film with parallel grooves filled with resin containing anisotropic light diffusion particles, wherein the length of the particles is greater than the width of the grooves.

### CROSS-REFERENCE TO RELATED APPLICATION

This application is a by-pass continuation application of International Application No. PCT/KR2023/019768, filed on Dec. 4, 2023, which is based on and claims priority to Korean Patent Application No. 10-2023-0008911, filed on Jan. 20, 2023, in the Korean Intellectual Property Office, the disclosures of which are incorporated by reference herein in their entireties.

### 1. FIELD

The present disclosure relates to a light diffusion film, a method of manufacturing the light diffusion film, and a display apparatus including a light diffusion film that diffuses light anisotropically, a method of manufacturing the light diffusion film, and a display apparatus.

### 2. Description of Related Art

In the related art, a light diffusion film has been used in a display apparatus. In order to improve the viewing angle of the display apparatus, a light diffusion film having anisotropic light diffusion properties is attached and used.

Because display apparatuses usually have different aspect ratios, in order to improve the viewing angle of the display apparatus, it may diffuse a greater amount of light in the horizontal direction.

In response to such a demand, the anisotropic light diffusion film is manufactured to have optical properties along the longitudinal direction of the display apparatus, and the manufacturing equipment is also manufactured to perform processes along a direction.

As display panels have become larger, the size of the anisotropic light diffusion film may also be enlarged. In such cases, it may become challenging to continue using manufacturing systems without adjustments, and expanding the production setup might involve additional effort or expense.

### SUMMARY

According to an aspect of the disclosure, a method of manufacturing a light diffusion film includes preparing a cylindrical drum having protrusions extending in a length direction on an outer circumferential surface of the cylindrical drum; moving a base film having a defined width in a first direction; rubbing the cylindrical drum on the base film and forming a plurality of grooves on the base film, the plurality of grooves extending in a second direction perpendicular to the first direction; supplying, to the moving base film, a mixture having anisotropic light diffusion particles and a resin to fill the plurality of grooves; and curing the resin of the mixture in the plurality of grooves.

The method may include wherein a length of the anisotropic light diffusion particles is greater than a width of the plurality of grooves.

The method may include wherein the anisotropic light diffusion particles have a defined diameter, and a ratio of the diameter to the length of the anisotropic light diffusion particles is 1:5 to 1:100.

The method may include wherein the supplying of the mixture to the base film further comprises supplying of the mixture to the base film based on using an application device, the application device having a defined width and extending in the second direction.

The method may include wherein the application device sprays the mixture to the base film.

The method may include wherein the application device squeezes the mixture to the base film.

The method may include wherein the supplying of the mixture to the base film further comprises applying vibration to a transport device.

The method may further include after the supplying the mixture to the base film, scraping mixture located outside the plurality of grooves from the base film.

The method may further include after the supplying the mixture to the base film, attaching a protective film.

The method may include wherein the curing the resin comprises irradiating light to the mixture based on using an irradiation device, the irradiation device extending in the second direction and having a defined length.

The method may include wherein the protrusions of the cylindrical drum have a semicircular cross-section that forms the plurality of grooves with a semicircular cross-section.

The method may include wherein the protrusions of the cylindrical drum have a rectangular cross-section that forms the plurality of grooves with a rectangular cross-section.

The method may include wherein the protrusions of the cylindrical drum have a triangular cross-section that forms the plurality of grooves with a triangular cross-section.

According to another aspect of the disclosure, a light diffusion film includes a base film comprising a short side and a long side; a plurality of grooves formed on a surface of the base film, wherein the plurality of grooves extend in parallel with respect to the short side of the base film and are arranged along the long side of the base film; a resin filling the plurality of grooves; and a plurality of anisotropic light diffusion particles dispersed in the resin, each of the anisotropic light diffusion particles comprising a defined diameter and a defined length to anisotropically diffuse light, wherein the defined length of each of the anisotropic light diffusion particles is greater than a width of each of the plurality of grooves.

The light diffusion film may include wherein a ratio of the defined diameter to the defined length of the anisotropic light diffusion particles is 1:5 to 1:100.

The above and other aspects, features, and advantages of certain embodiments of the present disclosure are more apparent from the following description taken in conjunction with the accompanying drawings, in which:

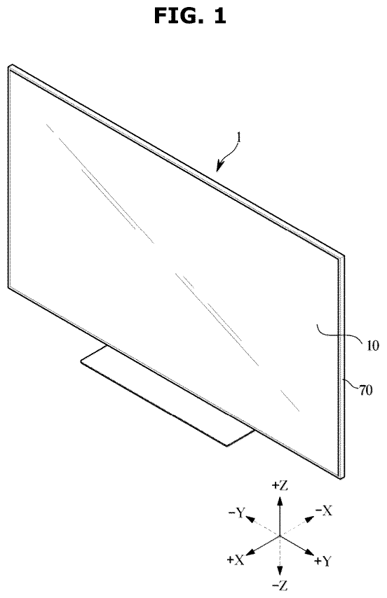

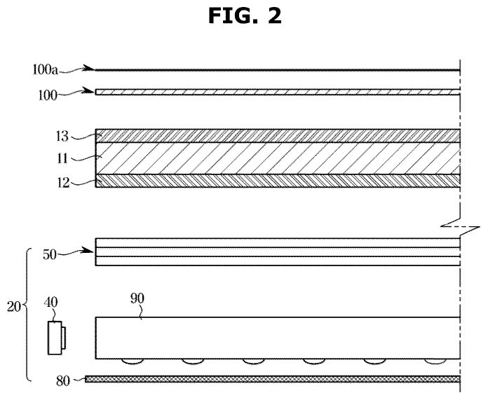

FIG. 1 is a perspective view illustrating a display apparatus according to an embodiment.

FIG. 2 is a view briefly illustrating the internal configuration of a light diffusion film and a display apparatus according to an embodiment.

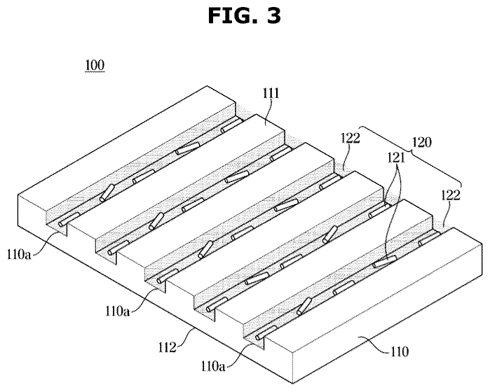

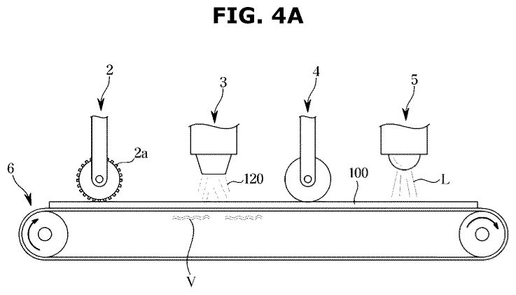

FIG. 3 is a view illustrating a structure of a light diffusion film according to an embodiment.

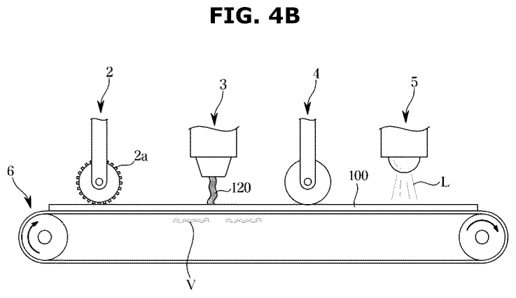

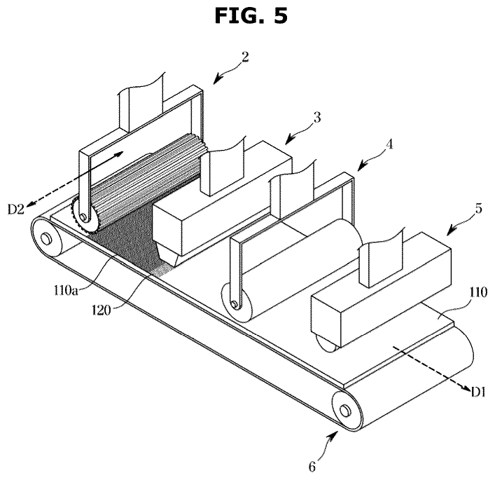

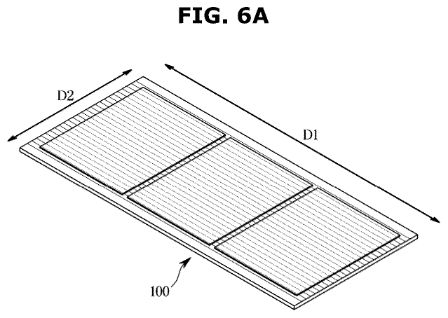

FIGS. 4A and 4B are views briefly illustrating a method of manufacturing the light diffusion film illustrated in FIG. 3.
FIG. 5 is a perspective view illustrating a method of manufacturing the light diffusion film illustrated in FIG. 3.

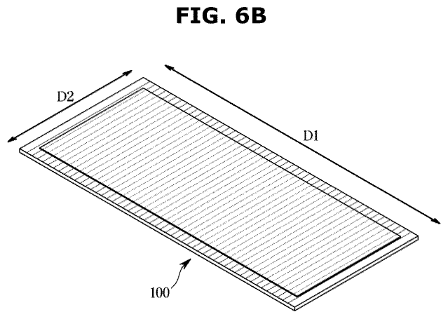

FIGS. 6A and 6B are views for comparing the sizes according to the manufacturing direction of the light diffusion film.

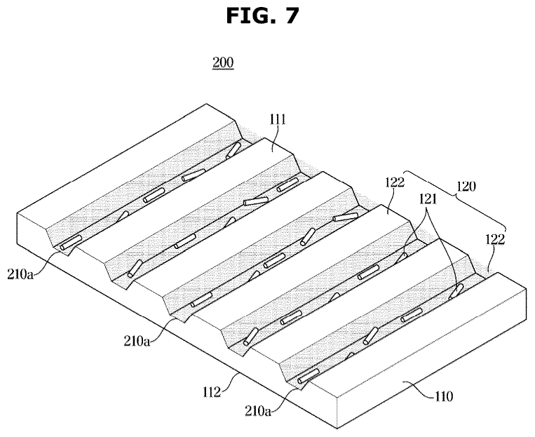

FIG. 7 is a view illustrating a light diffusion film having a groove with a rectangular cross-section.

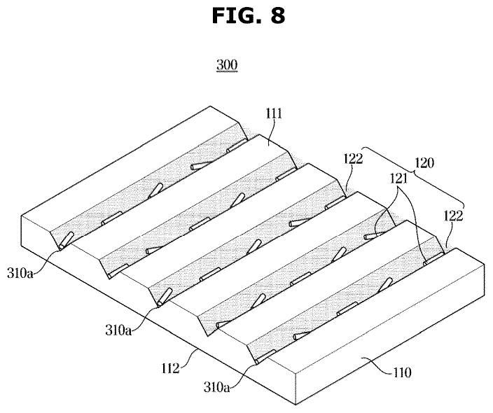

FIG. 8 is a view illustrating a light diffusion film having a groove with a triangular cross-section.

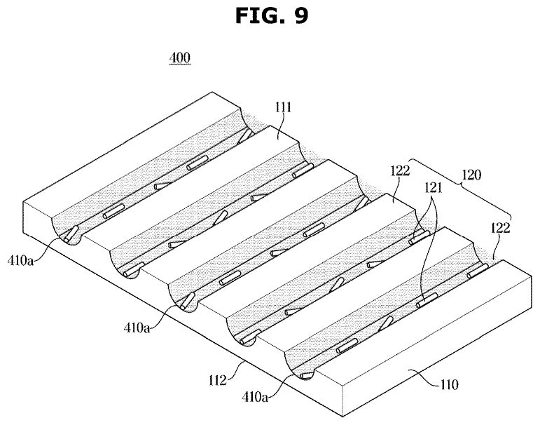

FIG. 9 is a view illustrating a light diffusion film having a groove with a semicircular cross-section.

### DETAILED DESCRIPTION

Various embodiments of this document and the terms used in the embodiments are not intended to limit the technical features disclosed in this document to the particular embodiments and should be understood as including various alterations, equivalents, or alternatives of the corresponding embodiments.

The embodiments described in the disclosure, and the configurations shown in the drawings, are only examples of embodiments, and various modifications may be made without departing from the scope and spirit of the disclosure.

In connection with the description of the drawings, the similar reference numerals may be used for the similar or relevant constituent elements.

The singular form of a noun corresponding to an item may include one or plurality of the items, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

The term “and/or” includes a combination of a plurality of related constituent elements or any constituent element among the plurality of related constituent elements.

Such terms as “1st” and “2nd,” or “first” and “second” may be used to simply distinguish a corresponding constituent element from another, and does not limit the constituent elements in other aspect (e.g., importance or order).

When a constituent element (e.g., a first constituent element) is referred to, with or without the term “operatively” or “communicatively,” as “coupled with,” “coupled to,” “connected with,” or “connected to” another constituent element (e.g., a second constituent element), it means that the constituent element may be coupled with the other constituent element directly (e.g., wiredly), wirelessly, or via a third constituent element.

It should be understood the terms “comprises,” “comprising,” “includes,” “including,” “containing,” “has,” “having” or other variations thereof are inclusive and therefore specify the presence of stated features, integers, steps, operations, elements, components, or combinations thereof disclosed in this document, but do not preclude the presence or addition of one or more other features, integers, steps, operations, elements, components, or combinations thereof.

When a constituent element is said to be “connected,” “coupled,” “supported,” or “in contact” with another constituent element, this includes not only cases where the constituent elements are directly connected, coupled, supported, or in contact with each other, but also cases where they are indirectly connected, coupled, supported, or in contact through a third constituent element.

When a constituent element is said to be positioned “on” another constituent element, this includes not only cases where the constituent element is in direct contact with the other constituent element, but also cases where another constituent element exists between the two constituent elements.

The terms used in this disclosure are used for the purpose of describing embodiments and are not intended to limit and/or restrict the present disclosure. Singular expressions include plural expressions unless clearly described as different meanings in the context. In this disclosure, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

Terms such as “first,” “second,” and the like, which include ordinal numbers, may be used to describe various constituent elements in this disclosure, but the constituent elements are not limited by these terms. These terms are used solely for the purpose of distinguishing one constituent element from another constituent element. For example, a first component may be named a second component, and similarly, the second component may also be named the first component, without departing from the scope of the present disclosure. The term “and/or” includes any and all combinations of a plurality of the related and listed items.

Meanwhile, terms such as “upward and downward direction”, “lower side”, “frontward and rearward direction”, and the like used in the following description, are defined based on the drawings, and the shapes and positions of the respective constituent elements are not limited by these terms.

Hereinafter, embodiments according to the present disclosure will be described in detail with reference to the accompanying drawings.

FIG. 1 is a perspective view illustrating a display apparatus according to an embodiment. FIG. 2 is a view briefly illustrating the internal configuration of a light diffusion film and a display apparatus according to an embodiment.

With reference to FIG. 1, a display apparatus 1 according to an embodiment may be a self-emissive display apparatus in which light-emitting elements are disposed for each pixel, so that each pixel may emit light by itself. The present disclosure is not limited thereto, and the display apparatus 1 may be a light-receiving display apparatus that emits light using external light, such as a liquid crystal display (LCD). In this illustration, for the convenience of explanation, a light-receiving display apparatus employing an LCD is described as a reference.

The present disclosure describes a planar display apparatus 1 as an example; however, the display apparatus 1 may be implemented not only as a flat display apparatus but also as a curved display apparatus having a screen with a fixed curvature, or a curvature-variable display apparatus with a screen whose curvature is adjustable, and it will be easily understood by those skilled in the art that the present disclosure is not limited thereto.

Meanwhile, the three-dimensional coordinate system of the XYZ axes illustrated in FIG. 1 is defined based on the display apparatus 1, and the plane in which the screen of the display apparatus 1 is located corresponds to the YZ plane, and the direction in which the image is output corresponds to the +X direction.

Because the display apparatus 1 is used in an upright state and the user views the image from the front of the display apparatus 1, the +X direction in which the image is output may be referred to as the front direction, and the opposite direction may be referred to as the rear direction.

Because the coordinate system illustrated is defined based on the display apparatus 1, the same coordinate system may be applied both when the display apparatus 1 is lying down and when it is standing up.

With reference to FIGS. 1 and 2, the display apparatus 1 includes therein a display module for displaying an image. The display module includes a display panel 10 on which the image is displayed, and a backlight unit 20 that supplies light to the display panel 10.

The backlight unit 20 may be configured to allow light to be delivered to the display panel 10 in a surface direction. The backlight unit 20 may include a printed circuit board (not illustrated), a light source module 40, a light guide plate 90, and a plurality of optical sheets 50. That is, the backlight unit 20 may include the light source module 40 disposed at the rear of the display panel 10, the light guide plate 90 disposed in the space between the display panel 10 and the light source module 40, to diffuse light supplied from the light source module 40 and deliver the light to the display panel 10 located at the front, and the plurality of optical sheets 50 disposed between the display panel 10 and the light source module 40, to change optical properties.

The display apparatus 1 may include a middle mold 60 supporting the display panel 10, and a display chassis 70 forming the exterior. The display chassis 70 includes a top chassis 72 coupled to the front side of the middle mold 60, to maintain the state in which the display panel 10 is installed on the middle mold 60, and a bottom chassis 76 coupled to the rear of the middle mold 60, in which the above-described light source module 40 is disposed on both sides of the interior. The light source module 40 is disposed in front of the bottom chassis 76 and may irradiate light toward the display panel 10. The light source module 40 may include a light-emitting element that emits blue light. The blue light may be converted into at least one of red light, green light, or blue light. In the embodiment of the present disclosure, an edge-type display method is described, but the present disclosure is not limited thereto and may also be applied to a direct-type display method.

A plurality of light source modules 40 may be mounted on the printed circuit board (not illustrated). The size of the printed circuit board (not illustrated) may correspond to the length of the display panel 10 in upward and downward direction. In this embodiment, the plurality of light source modules 40 are arranged to correspond to the height in the upward and downward direction of the display apparatus, but the arrangement of the plurality of light source modules 40 is not limited thereto.

A reflection sheet 80 reflects light irradiated from the light source module 40 toward the display panel 10, or re-reflects light, which is re-reflected by the optical sheet 50, the display panel 10, or the like, toward the display panel 10. The reflection sheet 80 is disposed on the front surface of the printed circuit board (not illustrated), and reflects leaked light toward the display panel 10, thereby improving light efficiency. The reflection sheet 80 may be disposed on the rear surface of the light guide plate 90. The reflection sheet 80 may be coated with a high-reflectivity coating material of white or silver color (e.g., silver, TiO₂). The reflection sheet 80 may include a reflective plate.

The plurality of optical sheets 50 may allow light, which is irradiated from the light source module 40 and directed toward the display panel 10, to have uniform luminance. The light having uniform luminance that has passed through the plurality of optical sheets 50 is incident on the display panel 10. The plurality of optical sheets 50 may include a protective sheet, a prism sheet, or a diffuser sheet. The optical sheet may include at least one sheet. In addition to the above-described optical sheets, various types of optical sheets may be used to improve the optical properties of light.

The display panel 10 may display an image by converting an electrical signal into an optical signal. The display panel 10 may include a liquid crystal panel 11, and polarizers 12 and 13.

The liquid crystal panel 11 is provided in front of the backlight unit 20, and blocks or transmits the light emitted from the backlight unit 20 to form an image. The front surface of the liquid crystal panel 11 forms the screen of the previously described display apparatus 1, and may be composed of a plurality of pixels. The plurality of pixels included in the liquid crystal panel 11 may independently block or transmit light from the backlight unit 20, and the light transmitted through the plurality of pixels may form an image displayed on the display apparatus 1.

The liquid crystal panel 11 may include first and second transparent substrates (not illustrated) and a liquid crystal layer (not illustrated). The liquid crystal panel 11 may include pixel electrodes, thin film transistors, common electrodes, and a color filter (not illustrated). The first and second transparent substrates (not illustrated) form the exterior of the liquid crystal panel 11, and may protect the liquid crystal layer (not illustrated) and the color filter, which are provided therebetween. The first and second transparent substrates (not illustrated) may be composed of tempered glass or transparent resin.

Liquid crystal represents an intermediate state between a solid (crystal) and a liquid. With typical materials, when heat is applied to a material in a solid state, a phase change occurs from a solid state to a transparent liquid state at the melting temperature. In contrast, when heat is applied to a liquid crystal material in a solid state, the liquid crystal material changes to an opaque and cloudy liquid at the melting temperature, and then to a transparent liquid state. Most of such liquid crystal materials are organic compounds, and their molecular shapes are slender and long rod-shaped, where the arrangement of the molecules is like an irregular state in some directions, but in other directions, they may have the form of regular crystals. As a result, the liquid crystal has both the fluidity of a liquid and the optical anisotropy of a crystal (solid).

The liquid crystal may also exhibit optical properties depending on a change in an electric field. For example, the direction of molecular arrangement constituting the liquid crystal may change according to the change in the electric field. When an electric field is generated in the liquid crystal layer (not illustrated), liquid crystal molecules of the liquid crystal layer (not illustrated) are disposed according to the direction of the electric field, and when no electric field is generated in the liquid crystal layer (not illustrated), the liquid crystal molecules may be disposed irregularly or may be disposed along an alignment film (not illustrated).

As a result, the optical properties of the liquid crystal layer may vary depending on the presence or absence of an electric field passing through the liquid crystal layer (not illustrated). For example, when no electric field is formed in the liquid crystal layer (not illustrated), due to the disposition of the liquid crystal molecules in the liquid crystal layer (not illustrated), light polarized by a first polarizing film (not illustrated) may pass through the liquid crystal layer (not illustrated) and then pass through a second polarizing film (not illustrated). On the other hand, when an electric field is formed in the liquid crystal layer (not illustrated), the disposition of the liquid crystal molecules in the liquid crystal layer (not illustrated) is changed such that the light polarized by the first polarizing film (not illustrated) may not pass through the second polarizing film (not illustrated).

The display apparatus 1 may include a light diffusion film 100 attached to the front surface of the display panel 10. The light diffusion film 100 may have a property of diffusing light. By diffusing light emitted from the display panel 10, the viewing angle of the display apparatus 1 may be improved.

The light diffusion film 100 may be provided in a size corresponding to the display panel 10 in order to cover the front surface of the display panel 10. The light diffusion film 100 may have one surface 111 or the other surface 112 attached to the display panel 10. Because light may pass through the light diffusion film 100, when anisotropic light diffusion particles 121 are present therein, the light may be diffused. Accordingly, even when either one surface 111 or the other surface 112 of the light diffusion film 100 is attached, the light may be diffused.

The light diffusion film 100 may be an anisotropic light diffusion film that diffuses light anisotropically. Because a user viewing the display apparatus 1 may view the display apparatus 1 from the left and right directions of the display apparatus 1, it may diffuse more light in the left and right directions. Through this, the viewing angle of the display apparatus 1 may be improved.

FIG. 3 is a view illustrating a structure of a light diffusion film according to an embodiment. FIGS. 4A and 4B are views briefly illustrating a method of manufacturing the light diffusion film illustrated in FIG. 3. FIG. 5 is a perspective view illustrating a method of manufacturing the light diffusion film illustrated in FIG. 3.

With reference to FIGS. 3 to 5, the light diffusion film 100 may have a short side and a long side. The display panel 10 of the display apparatus 1 illustrated in FIG. 1 is provided such that the length in the left and right direction and the length in the upward and downward direction are different. Accordingly, in order for the light diffusion film 100 to be attached to the display panel 10 in FIG. 1, the light diffusion film 100 may have a short side corresponding to the length in the upward and downward direction, and a long side corresponding to the length in the left and right direction. The present disclosure is not limited thereto, and when the display panel 10 is formed in a square shape in which the length in the left and right direction and the length in the upward and downward direction are provided as equal, the short side and the long side of the light diffusion film 100 may be indistinguishably provided with the same length.

The light diffusion film 100 may include a base film 110. A groove 110a to be described below may be formed on one surface 111 of the base film 110. Because a pattern needs to be formed on the base film 110 in order to be mass-produced as the light diffusion film 100, the base film 110 needs to be continuously moved in a first direction D1. Accordingly, the base film 110 needs to be formed to be long in the first direction D1. In this case, it is preferable that the base film 110 is wound in a roll form. In this illustration, only the base film 110 in a spread state is illustrated for the convenience of description, but it is obvious that the base film 110 is provided to be long in order to be mass-produced.

The light diffusion film 100 may include anisotropic light diffusion particles 121. The anisotropic light diffusion particles 121 may be provided to have a defined length. The anisotropic light diffusion particles 121 may have a substantially rod shape so that light is anisotropically diffused. When the anisotropic light diffusion particles 121 are close to a spherical shape, they exhibit a stronger property of isotropically diffusing light, and thus the anisotropic light diffusion particles 121 may be formed in a certain extent of elongated shape. In this illustration, the anisotropic light diffusion particles 121 are illustrated as having a substantially cylindrical shape. The present disclosure is not limited thereto, and the anisotropic light diffusion particles 121 may have a shape such as a substantially elliptical shape, a rod, or a needle.

The anisotropic light diffusion particles 121 have a defined length, and when they are disposed in the length direction, the light may be diffused in a direction perpendicular to the length direction rather than in the length direction. As described above, the degree of diffusion may differ depending on the direction. For example, when the anisotropic light diffusion particles 121 are disposed along the upward and downward direction of the display panel 10, light emitted from the display panel 10 may be diffused along the left and right direction rather than along the upward and downward direction. By this principle, the viewing angle of the display panel 10 may be improved in the left and right direction.

When the display panel 10 is used in a television (TV), it may secure a viewing angle in the left and right directions. In this case, the anisotropic light diffusion particles 121 need to be disposed along the upward and downward direction of the display panel 10. Because the anisotropic light diffusion particles 121 need to cover the front surface of the display panel 10, the length direction of the anisotropic light diffusion particles 121 need to be disposed along the upward and downward direction, and to be repeated in the left and right direction so that the anisotropic light diffusion particles 121 may be disposed over the front surface of the display panel 10.

As such, to allow the length direction of the anisotropic light diffusion particles 121 to be disposed along the upward and downward direction of the display panel 10 and to be repeated in the left and right direction within the light diffusion film 100, it is needed to provide a plurality of grooves 110a formed along the upward and downward direction in the light diffusion film 100. The plurality of grooves 110a may be repeated along the left and right direction. In order to manufacture such a light diffusion film 100, it may form the plurality of grooves 110a in the base film 110 along the first direction D1, and to dispose the anisotropic light diffusion particles 121 within the plurality of grooves 110a.

Additionally, the base film 110 needs to be manufactured to match the size of the display panel 10 to which the light diffusion film 100 is to be applied. In summary, the light diffusion film 100 is provided to have a width corresponding to the length in the left and right direction of the display panel 10, and the anisotropic light diffusion particles 121 may be disposed while the base film 110 moves in the length direction, that is, in the first direction D1.

In this case, in order to manufacture the light diffusion film 100 to be applied to a large-sized display panel 10, a base film 110 having a larger width, a larger transport device 6 for moving the base film 110, and a larger application device 3 for disposing the anisotropic light diffusion particles 121 on the base film 110 may be needed. That is, in order to manufacture the light diffusion film 100 to be applied to the large-sized display panel 10, a significant cost may be incurred to scale up the manufacturing equipment. Manufacturing the light diffusion film 100 using large-scale equipment requires a higher level of difficulty, and as the scale increases, the amount of material lost may also increase.

According to the method of manufacturing the light diffusion film 100 of the present disclosure, as illustrated in FIGS. 4 and 5, it is possible to manufacture the light diffusion film 100 applicable to the large-sized display panel 10 even with the existing light diffusion film 100 manufacturing equipment.

First, a cylindrical drum 2 comprising protrusions 2a extending along the length direction on the outer circumferential surface thereof may be prepared. The drum 2 may be fixed to a support, and may rotate according to the movement of the base film 110, thereby forming the grooves 110a on the base film 110. By varying the shape of the protrusions 2a of the drum 2, the shape of the plurality of grooves 110a to be formed on the base film 110 may be determined. In this illustration, the protrusions 2a of the drum 2 are illustrated as having a shape with a substantially rectangular cross-section, but they may also have a triangular or semicircular cross-section, which will be described below.

Thereafter, the base film 110 may be seated on the transport device 6. Specifically, in order to form the grooves 110a on one surface 111 of the base film 110, the other surface 112 of the base film 110 may be brought into contact with the transport device 6. The transport device 6 may move the base film 110 in the first direction D1. For example, the base film 110 may be moved by the transport device 6 such as a conveyor belt.

The base film 110 may have the grooves 110a formed by the protrusions 2a of the drum 2. That is, the drum 2 may be rubbed on one surface 111 of the base film 110 to form the plurality of grooves 110a that extend in a second direction D2 perpendicular to the first direction D1 on the base film 110. The anisotropic light diffusion particles 121 may be located in the plurality of grooves 110a.

The anisotropic light diffusion particles 121 may have a very small size. Even if they are supplied to the base film 110, it may be difficult to fix them without a separate fixing means. Therefore, they may be mixed with a liquid resin 122. For example, the resin 122 may be an acrylate, urethane, epoxy, or silicone resin. By mixing the anisotropic light diffusion particles 121 into the liquid resin 122, a mixture 120 may be prepared. To evenly disperse the anisotropic light diffusion particles 121 within the grooves 110a, they may be mixed with the liquid resin 122 and applied. Because the liquid resin 122 has a flowing property, it may flow and move into the grooves 110a.

To supply the mixture 120 of the anisotropic light diffusion particles 121 and the liquid resin 122 onto the base film 110, the application device 3 extending in the second direction D2 and having a defined width may be used. The light diffusion film 100 applicable to a large-sized display panel 10 may be manufactured using the application device 3 having the same width as the width of the base film 110.

The supplying of the mixture 120 of the anisotropic light diffusion particles 121 and the liquid resin 122 onto the base film 110 may include applying vibration V to the transport device 6. This may not necessarily involve artificially applying vibration V, but may include the vibration V naturally generated by the transport device 6. Because the anisotropic light diffusion particles 121 need to diffuse light in a defined direction, they need to be located within the plurality of grooves 100a, and their length direction needs to be directed toward the second direction D2, which is the extension direction of the grooves 110a. Therefore, it is needed to prevent the anisotropic light diffusion particles 121 from being located outside the grooves 110a.

The defined length of the anisotropic light diffusion particle 121 may be formed to be greater than the width of the plurality of grooves 110a. When the length of the anisotropic light diffusion particle 121 is smaller than the width of the plurality of grooves 110a, the anisotropic light diffusion particle 121 may not be introduced in a direction perpendicular to the extension direction of the plurality of grooves 110a, that is, in a direction perpendicular to the second direction D2. The length direction of the anisotropic light diffusion particle 121 may need to form at least an acute angle with the second direction D2, which is the extension direction of the plurality of grooves 110a. Therefore, in order to prevent the introduction in a direction perpendicular to the second direction D2, the length of the anisotropic light diffusion particle 121 needs to be formed to be greater than the width of the plurality of grooves 110a.

The anisotropic light diffusion particles 121 may have a defined diameter. The anisotropic light diffusion particles 121 may not necessarily have a substantially rotational body shape, but because the anisotropic light diffusion particles 121 are formed with a minute size, even if the term diameter is used, it may be understood. That is, the diameter referred to herein may not necessarily mean the diameter of a cross-section in a direction perpendicular to the rotational axis of a rotational body.

The ratio of diameter to length of the anisotropic light diffusion particles 121 may be formed to be approximately 1:5 to 1:100. In other words, it may be the aspect ratio of the anisotropic light diffusion particle 121. As the ratio of diameter to length of the anisotropic light diffusion particles 121 becomes smaller, the degree to which light is diffused in the left and right directions may become smaller. Because the length of the anisotropic light diffusion particles 121 is relatively short, a greater number of anisotropic light diffusion particles 121 may be introduced into the groove 110a. Accordingly, the uniformity of the anisotropic light diffusion particles 121 distributed across the entire display panel 10 may be increased.

As the ratio of diameter to length of the anisotropic light diffusion particles 121 becomes greater, the degree to which light is diffused in the left and right directions may become greater. In this case, the length of the anisotropic light diffusion particles 121 is relatively long, so the amount of anisotropic light diffusion particles 121 introduced into the groove 110a may be small. During the manufacturing process, it may be difficult to supply the anisotropic light diffusion particles 121 into the groove 110a. As a result, the uniformity of the anisotropic light diffusion particles 121 distributed across the entire display panel 10 may be decreased.

The application device 3 may spray the mixture 120 of the anisotropic light diffusion particles 121 and the liquid resin 122. Alternatively, the application device 3 may squeeze the mixture 120 of the anisotropic light diffusion particles 121 and the liquid resin 122. The application device 3 may entirely and uniformly apply the mixture 120 to the grooves 110a formed in the base film 110.

After the mixture 120 of the anisotropic light diffusion particles 121 and the liquid resin 122 is supplied to the base film 110 by the application device 3, the mixture 120 may also be applied to portions other than the grooves 110a. Because the anisotropic light diffusion particles 121 need to be located in the grooves 110a, there may be a process of scraping off the mixture 120 located in portions other than the grooves 110a. In the scraping process, a scraper 4 may be used.

The scraper 4 may be provided to be substantially like a roller. The scraper 4 may be closely located so as to remove the mixture 120 outside the groove 110a while preventing damage to the base film 110. The driving method of the scraper 4 is not limited thereto and may be provided in a plate or wedge shape.

Alternatively, a protective film 100a may be attached to one surface of the base film 110 to which the mixture 120 is applied. As the protective film 100a is attached, the mixture 120 outside the groove 110a may be pushed out by the protective film 100a. In this case, the mixture 120 pushed out may be removed. There may be no void between the protective film 100a, the base film 110, and the groove 110a filled with the mixture 120.

The protective film 100a may also protect the display panel 10. The protective film 100a may be attached to the front surface of the diffusion film 100, and may increase clarity or improve durability. The protective film 100a may be a superclear film or an SLR film.

Because the resin 122 present in the mixture 120 filled in the groove 110a is in a liquid phase, it needs to be cured in order to be attached to the display panel 10. To cure the liquid resin 122, light L may be irradiated. To cure the resin 122 of the mixture 120 filled in the groove, an irradiation device 5 extending in the second direction D2 and having a defined width may be used.

The irradiation device 5 may be a linear light source having a defined width. Because the irradiation device 5 has a defined length along the second direction D2, which is the direction in which the plurality of grooves 110a extend, the resin 122 filled in the plurality of grooves 110a may be evenly cured. The defined length of the irradiation device 5 may be identical to or similar to the defined width of the base film 110. The irradiation device 5 may be the disposition of point light sources in a straight line. Even in this case, the resin 122 filled in the plurality of grooves 110a may be evenly cured. The irradiation device 5 for curing the resin 122 may emit ultraviolet (UV) light. The present disclosure is not limited thereto, and the resin 122 may also be cured by mixing the resin 122 with a curing agent.

As described above, the light diffusion film 100 according to the present disclosure may include a short side and a long side. In order for the light diffusion film 100 to be applied to the display apparatus 1, the light diffusion film 100 may have a short side and a long side.

With reference to FIGS. 3 and 5, the light diffusion film 100 manufactured by the above-described manufacturing method may have a width along the second direction D2 and a length along the first direction D1. That is, the light diffusion film 100 may have a long side in the first direction D1 and a short side in the second direction D2. In other words, the light diffusion film 100 may include the base film 110 having a long side in the first direction D1 and a short side in the second direction D2.

The light diffusion film 100 may include the plurality of grooves 110a formed on one surface 111 of the base film 110. The plurality of grooves 110a may extend in parallel with respect to the short side in the second direction D2. That is, the plurality of grooves 110a may extend along the second direction D2.

The plurality of grooves 110a may be arranged along the long side in the first direction D1. The plurality of grooves 110a may be arranged along the first direction D1. As such, the plurality of grooves 110a may form a substantially striped pattern on one surface 111 of the base film 110. By disposing the anisotropic light diffusion particles 121 in the pattern, optical properties capable of anisotropically diffusing light may be obtained.

The light diffusion film 100 may include the resin 122 filling the plurality of grooves 110a, and the anisotropic light diffusion particles 121 dispersed in the resin 122. As described above, the anisotropic light diffusion particles 121 may have a defined diameter and length to anisotropically diffuse light.

In order to prevent the anisotropic light diffusion particles 121 from being introduced in a direction perpendicular to the extension direction of the plurality of grooves 110a, that is, the second direction D2, the length of the anisotropic light diffusion particles 121 may be formed greater than the width of the plurality of grooves 110a.

FIGS. 6A and 6B are views for comparing the sizes according to the manufacturing direction of the light diffusion film.

With reference to FIG. 6A, the light diffusion film 100 has the plurality of grooves 110a (see FIG. 3) formed along the first direction D1, that is, the anisotropic light diffusion particles 120 are disposed. The plurality of grooves 110a are arranged along the second direction D2. To be used for the display panel 10 having a longer length in the left and right direction, the light diffusion film 100 needs to be cut in the second direction D2. In this case, the size of the display panel 10 to which the light diffusion film 100 in FIG. 6A may be applied may correspond to approximately one third of the entire light diffusion film 100 illustrated.

On the other hand, with reference to FIG. 6B, the light diffusion film 100 may have the plurality of grooves 110a (see FIG. 3) formed along the second direction D2. The plurality of grooves 110a may be arranged along the first direction D1. To be used for the display panel 10 having a longer length in the left and right direction, the light diffusion film 100 may not be cut in the first direction D1, and the entire defined width of the light diffusion film 100 may be used.

When the length in the left and right direction of the display panel 10 is shorter than the length in the first direction D1 of the light diffusion film 100 illustrated in FIG. 6B, the light diffusion film 100 may be cut along the second direction D2.

As such, it is possible to manufacture the light diffusion film 100 applicable to a larger display panel 10 even without scaling up the manufacturing equipment of the light diffusion film 100. The manufacture of the light diffusion film 100 for application to a large-sized display panel 10 may be facilitated, and the cost may be reduced.

Hereinafter, detailed descriptions of the same configurations as those described in FIGS. 1 to 6 may be omitted.

FIG. 7 is a view illustrating a light diffusion film having a groove with a rectangular cross-section. FIG. 8 is a view illustrating a light diffusion film having a groove with a triangular cross-section. FIG. 9 is a view illustrating a light diffusion film having a groove with a semicircular cross-section.

With reference to FIGS. 7 to 9, a light diffusion film 200 may have a cross-section of a plurality of grooves 210a that has substantially an inverted trapezoidal shape. To manufacture the plurality of grooves 210a having a cross-section of an inverted trapezoidal shape, the protrusions 2a of the drum 2 (see FIG. 4) may be provided in a substantially trapezoidal shape. The present disclosure is not limited thereto, and the cross-section may also have a trapezoidal shape.

A light diffusion film 300 may have a cross-section of a plurality of grooves 310a that has substantially an inverted triangular shape. To manufacture the plurality of grooves 310a having a cross-section of an inverted triangular shape, the protrusions 2a of the drum 2 (see FIG. 4) may be provided in a substantially triangular shape.

A light diffusion film 400 may have a cross-section of a plurality of grooves 410a that has substantially a semicircular shape. To manufacture the plurality of grooves 410a having a cross-section of a semicircular shape, the protrusions 2a of the drum 2 (see FIG. 4) may be provided in a substantially semicircular shape. In other words, the plurality of grooves 410a may have a shape of a substantially lenticular lens.

The cross-sections is not limited to the shapes illustrated, and may also be in a combined form of the cross-sections of rectangular, trapezoidal, triangular, and semicircular shapes. Other shapes may also be combined, and some of them may be combined.

As such, the light diffusion films 200, 300, and 400 may have various shapes of the plurality of grooves 210a, 310a, and 410a, which are provided such that the anisotropic light diffusion particles 121 may be located. The shapes of the plurality of grooves 210a, 310a, and 410a are not limited thereto, and may be provided in any shape as long the anisotropic light diffusion particles 121 may be accommodated.

A method of manufacturing a light diffusion film according to an embodiment includes: preparing a cylindrical drum 2 comprising protrusions 2a extending in a length direction on an outer circumferential surface thereof; moving a base film 110 having a defined width in a first direction D1; forming a plurality of grooves 110a extending in a second direction D2 perpendicular to the first direction D1 on the base film 110 by rubbing the drum on the base film 110; supplying, to the moving base film 110, a mixture 120 in which anisotropic light diffusion particles 121 and a resin 122 are mixed so as to fill the plurality of grooves 110a; and curing the resin 122 of the mixture 120 filled in the plurality of grooves 110a. According to the present disclosure, a light diffusion film may be easily manufactured. According to the present disclosure, a larger light diffusion film may be manufactured without large-scale equipment. According to the present disclosure, the manufacturing cost of the display apparatus may be reduced.

The length of the anisotropic light diffusion particles 121 may be formed greater than the width of the plurality of grooves 110a. According to the present disclosure, the anisotropic light diffusion particles may be disposed with directionality. According to the present disclosure, the anisotropic light diffusion efficiency may be increased. According to the present disclosure, the viewing angle of the display apparatus may be secured.

The anisotropic light diffusion particles 121 may have a defined diameter, and the ratio of the diameter to the length may be 1:5 to 1:100. According to the present disclosure, the manufacturing efficiency and uniformity may be optimized.

The supplying of the mixture 120 to the base film 110 may further include using an application device 3 that extends in the second direction D2 and has a defined width.

The application device 3 may spray the mixture 120.

The application device 3 may squeeze the mixture 120.

The supplying of the mixture 120 to the base film 110 may further include applying vibration to the transport device. According to the present disclosure, it is possible to facilitate the introduction of the mixture into the groove.

After the mixture 120 is supplied to the base film 110, the base film 110 may be scrapped. According to the present disclosure, it is possible to prevent the mixture from remaining outside the groove.

After the mixture 120 is supplied to the base film 110, a protective film may be attached. According to the present disclosure, the durability of the base film may be increased.

The curing of the resin 122 may include irradiating light using an irradiation device 5 that extends in the second direction D2 and has a defined length.

The protrusions of the drum may have a cross-section of a semicircular shape so as for the plurality of grooves 110a to have a cross-section of a semicircular shape.

The protrusions of the drum may have a cross-section of a rectangular shape so as for the plurality of grooves 110a to have a cross-section of a rectangular shape.

The protrusions of the drum may have a cross-section of a triangular shape so as for the plurality of grooves 310a to have a cross-section of a triangular shape.

A light diffusion film according to an embodiment may include a base film 110 including a short side and a long side; a plurality of grooves 110a formed on one surface of the base film 110, the plurality of grooves 110a extending in parallel with respect to the short side of the base film 110 and arranged along the long side of the base film 110; a resin 122 filling the plurality of grooves 110a; and anisotropic light diffusion particles 121 having a defined diameter and length to anisotropically diffuse light, and dispersed in the resin 122. The length of the anisotropic light diffusion particles 121 may be formed greater than the width of the plurality of grooves 110a. According to the present disclosure, the anisotropic light diffusion efficiency may be increased.

The ratio of the diameter to the length of the anisotropic light diffusion particles 121 may be 1:5 to 1:100.

The plurality of grooves 110a and 310a may have a cross-section of a rectangular or triangular shape.

A display apparatus according to an embodiment includes: a display panel 10; and a light diffusion film 100 provided in a size corresponding to the display panel 10, and attached to the display panel 10. The light diffusion film 100 includes: a base film 110 including a short side and a long side; a plurality of grooves 110a formed on one surface of the base film 110, the plurality of grooves 110a extending in parallel with respect to the short side of the base film 110 and arranged along the long side of the base film 110; a resin 122 filling the plurality of grooves 110a; and anisotropic light diffusion particles 121 dispersed in the resin 122 to diffuse light. The length of the anisotropic light diffusion particles 121 may be formed greater than the width of the plurality of grooves 110a. According to the present disclosure, the viewing angle of the display apparatus may be secured. According to the present disclosure, the manufacturing cost of the display apparatus may be reduced. According to the present disclosure, the anisotropic light diffusion efficiency may be increased.

The light diffusion film may be attached to the display panel such that one surface 111 or the other surface 112 of the base film 110 is attached to the display panel.

The light diffusion film may further include a protective film 100a that is attached to the light diffusion film. The protective film may be attached to one surface of the base film 110.

According to the present disclosure, the viewing angle of the display apparatus may be secured.

According to the present disclosure, the manufacturing cost of the display apparatus may be reduced.

According to the present disclosure, a light diffusion film may be easily manufactured.

According to the present disclosure, a larger light diffusion film may be manufactured without large-scale equipment.

According to the present disclosure, the anisotropic light diffusion efficiency may be increased.

The effects obtained by the present disclosure are not limited to the aforementioned effects, and other effects, which are not mentioned above, will be clearly understood by those skilled in the art from the following description.

The above describes and illustrates some embodiments. The present disclosure is not limited to the embodiments described above, and a person skilled in the art to which the present disclosure pertains would be able to make various modifications without departing from the scope of the technical spirit of the present disclosure as set forth in the following claims.

What is claimed is:

1. A method of manufacturing a light diffusion film, comprising:
preparing a cylindrical drum having protrusions extending in a length direction on an outer circumferential surface of the cylindrical drum;
moving a base film having a defined width in a first direction;
rubbing the cylindrical drum on the base film and forming a plurality of grooves on the base film, the plurality of grooves extending in a second direction perpendicular to the first direction;
supplying, to the moving base film, a mixture having anisotropic light diffusion particles and a resin to fill the plurality of grooves; and
curing the resin of the mixture in the plurality of grooves.

2. The method of claim 1, wherein
a length of the anisotropic light diffusion particles is greater than a width of the plurality of grooves.

3. The method of claim 2, wherein
the anisotropic light diffusion particles have a defined diameter, and
a ratio of the diameter to the length of the anisotropic light diffusion particles is 1:5 to 1:100.

4. The method of claim 1, wherein
the supplying of the mixture to the base film further comprises:
supplying of the mixture to the base film based on using an application device, the application device having a defined width and extending in the second direction.

5. The method of claim 4, wherein
the application device sprays the mixture to the base film.

6. The method of claim 4, wherein
the application device squeezes the mixture to the base film.

7. The method of claim 1, wherein
the supplying of the mixture to the base film further comprises:
applying vibration to a transport device.

8. The method of claim 1, further comprising:
after the supplying the mixture to the base film, scraping mixture located outside the plurality of grooves from the base film.

9. The method of claim 1, further comprising:
after the supplying the mixture to the base film, attaching a protective film.

10. The method of claim 1, wherein
the curing the resin comprises:
irradiating light to the mixture based on using an irradiation device, the irradiation device extending in the second direction and having a defined length.

11. The method of claim 1, wherein
the protrusions of the cylindrical drum have a semicircular cross-section that forms the plurality of grooves with a semicircular cross-section.

12. The method of claim 1, wherein
the protrusions of the cylindrical drum have a rectangular cross-section that forms the plurality of grooves with a rectangular cross-section.

13. The method of claim 1, wherein
the protrusions of the cylindrical drum have a triangular cross-section that forms the plurality of grooves with a triangular cross-section.

14. A light diffusion film, comprising:
a base film comprising a short side and a long side;
a plurality of grooves formed on a surface of the base film,
wherein the plurality of grooves extend in parallel with respect to the short side of the base film and are arranged along the long side of the base film;
a resin filling the plurality of grooves; and
a plurality of anisotropic light diffusion particles dispersed in the resin, each of the anisotropic light diffusion particles comprising a defined diameter and a defined length to anisotropically diffuse light,
wherein the defined length of each of the anisotropic light diffusion particles is greater than a width of each of the plurality of grooves.

15. The light diffusion film of claim 14, wherein
a ratio of the defined diameter to the defined length of the anisotropic light diffusion particles is 1:5 to 1:100.
